(19) United States
(12) Patent Application Publication
(10) Pub. No.: US 2002/0127471 A1
(43) Pub. Date: Sep. 12, 2002

(54) Rechargeable lithium storage cell

(75) Inventors: Clemence Siret, Bruges (FR); Frederic Castaing, Gradignan (FR); Philippe Biensan, Carignan de Bordeaux (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 10/028,918

(22) Filed: Dec. 28, 2001

(30) Foreign Application Priority Data
Jan. 4, 2001 (FR) 01 00 075

(51) Int. Cl. H01M 4/62; H01M 4/48

(52) U.S. Cl. 429/217; 429/231.1; 429/231.5; 29/623.1

(57) ABSTRACT

A rechargeable lithium storage cell includes a positive electrode, whose electrochemically active material includes one or more oxides of a transition metal, and a negative electrode, consisting of a conductive support and an active layer containing a binder and an electrochemically active material. The binder is a polymer containing no fluorine. The electrochemically active material is a mixed oxide of lithium and titanium with the general formula LiₓTi_{y}O₄ in which 0.8≦x≦1.4 and 1.6≦y≦2.2. The non-fluorinated polymer is preferably soluble in water or capable of forming a stable emulsion in suspension in water. The binder preferably contains an elastomer, especially an acrylonitrile/butadiene copolymer and/or a cellulose compound such as carboxymethylcellulose.

### CROSS-REFERENCE TO RELATED APPLICATIONS

This application is based on French Patent Application No. 01 00 075 filed Jan. 4, 2001, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to a rechargeable lithium storage cell including a negative electrode whose electrochemically active material is a mixed oxide of lithium and titanium.

2. Description of the Prior Art

Conventional organic electrolyte storage cell electrodes contain an electrochemically active material which constitutes a receiving structure into which cations, for example lithium cations, are inserted and from which they are extracted during cycling. Each electrode consists of a conductive support, serving as a current collector, and one or more active layers. It is produced by depositing on the support a paste containing the electrochemically active material, optional conductive additives, a polymer binder and a diluant.

The polymer binder of the electrode must firstly ensure the cohesion of the active material, which is in powder form, without masking a significant portion of the electrochemically active surface; this depends on the wetting properties of the binder. A compromise must be found because excessive interaction of the binder with the active material leads to excessive covering, which reduces the active surface area and consequently the capacity under high operating conditions. The reducing/oxidizing agents used as active materials are very powerful; the binder must have the lowest possible reactivity in order to be able to withstand extreme operating conditions without being degraded. Furthermore, the polymer binder must also allow adhesion of the paste to the current collector and accompany variations in the dimensions of the active material during charge and discharge cycles. It must also be compatible with the electrolytes used, of course.

The above objectives must be met not only when assembling the storage cell but also throughout its service life. To each active material there therefore correspond one or more binders enabling it to operate under optimum conditions.

The document EP-0 845 825 describes a rechargeable lithium storage cell including a negative electrode whose electrochemically active material is a carbon-containing material and a positive electrode whose electrochemically active material is a lithium titanate with the formula LiₓTi_{y}O₄ in which 0.8≦x≦1.4 and 1.6≦y≦2.2, in particular the lithium titanate in which x=1.33 and y=1.67. The positive electrode is prepared by mixing 70 wt % to 90 wt % of lithium titanate, 5 wt % to 20 wt % of a conductive agent, and 1 wt % to 10 wt % of a binder, and then compressing the mixture obtained. The binder is preferably a fluororesin such as polytetrafluoroethylene (PTFE), polyvinylidene fluoride (PVDF), etc.

The document JP-2000 106 217 concerns a nonaqueous electrolyte secondary storage cell including a positive electrode including Li_{4/3}Ti_{5/3}O₄ as the active material and a negative electrode including a lithium-doped carbon-containing material.

The document EP-0 617 474 describes a rechargeable lithium storage cell including a positive electrode whose electrochemically active material has a discharge potential of at least 2 V relative to Li/Li+, such as V₂O₅, LiMn₂O₄, LiCoO₂ or LiNiO₂, and a negative electrode whose electrochemically active material is an oxide of lithium and titanium with a spinel structure and the formula LiₓTi_{y}O₄, in which 0.8≦x≦1.4 and 1.6≦y≦2.2. The negative active material preferably has the formula Li_{4/3}Ti_{5/3}O₄. The negative electrode further includes up to 5 wt % of a fluorinated binder, such as polytetrafluoroethylene (PTFE).

Using PTFE and PVDF as the negative electrode binder causes significant reductions in capacity during cycling. The anti-adhesion properties of PTFE also rule out the use of a thin conductive support such as a tape, which is essential to obtaining high energies per unit volume.

An object of the present invention is to propose a rechargeable lithium storage cell including a negative electrode whose electrochemically active material is a mixed oxide of titanium and lithium and whose capacity remains more stable during successive charge/discharge cycles than that of prior art electrodes.

### SUMMARY OF THE INVENTION

The present invention provides a rechargeable lithium storage cell including a positive electrode, whose electrochemically active material includes one or more oxides of a transition metal, and a negative electrode, consisting of a conductive support and an active layer containing a binder and an electrochemically active material which is a mixed oxide of lithium and titanium with the general formula LiₓTi_{y}O₄ in which 0.8≦x≦1.4 and 1.6≦y≦2.2, in which storage cell the binder is a polymer containing no fluorine.

The binder is advantageously a non-fluorinated polymer soluble in water or forming a stable emulsion in suspension in water. Most binders routinely used at present are used in an organic solvent. This applies in particular to polyvinylidene fluoride (PVDF), which is dissolved in N-methylpyrrolidone (NMP). However, processes using organic solvents have disadvantages on the industrial scale because of the toxicity of the solvents employed and cost and safety problems relating to recycling a large volume of solvent. A particular requirement is therefore to use a binder compatible with aqueous solvents.

In a first embodiment of the invention, the binder contains an elastomer. The elastomers that can be used include ethylene/propylene/diene terpolymers (EPDM), styrene/butadiene copolymers (SBR), acrylonitrile/butadiene copolymers (NBR), styrene/butadiene/styrene block copolymers (SBS) or styrene/acrylonitrile/styrene block polymers (SIS), styrene/ethylene-butylene/styrene copolymers (SEBS), styrene/butadiene/vinylpyridine terpolymers (SBVR), polyurethanes (PU), neoprenes, polyisobutylenes (PIB), butyl rubbers, etc, and blends thereof. The elastomer is preferably a copolymer of butadiene and even more preferably the elastomer is chosen from an acrylonitrile/butadiene copolymer (NBR) and a styrene/butadiene copolymer (SBR). The proportion of the elastomer in the binder is preferably from 30 wt % to 70 wt %.

In a second embodiment of the invention, the binder contains a cellulose compound. The cellulose compound is preferably chosen from carboxymethylcellulose (CMC), hydroxypropylmethylcellulose (HPMC), hydroxypropylcellulose (HPC) and hydroxyethylcellulose (HEC). The cellulose compound is preferably carboxymethylcellulose (CMC). It is even more preferable if the carboxymethylcellulose (CMC) has an average molecular weight greater than approximately 200 000. The proportion of the cellulose compound in the binder is preferably from 30 wt % to 70 wt %.

In a third embodiment of the invention, the binder includes a mixture of an elastomer and a cellulose compound. In a first variant, the binder includes a mixture of an acrylonitrile/butadiene copolymer (NBR) and carboxymethylcellulose (CMC). In a second variant, the binder includes a mixture of a styrene/butadiene copolymer (SBR) and carboxymethylcellulose (CMC). The proportion of the elastomer in the binder is preferably from 30 wt % to 70 wt % and the proportion of the cellulose compound in the binder is preferably from 30 wt % to 70 wt %. It is even more preferable if the proportion of the elastomer in the binder is from 50 wt % to 70 wt % and the proportion of the cellulose compound in the binder is from 30 wt % to 50 wt %.

The rechargeable lithium storage cell according to the invention includes a negative electrode and a positive electrode, a separator disposed between the positive electrode and the negative electrode, and an electrolyte containing a conductive lithium salt dissolved in an organic solvent.

The current collector is preferably a two-dimensional conductive support such as a solid or perforated tape based on carbon or metal, for example copper, nickel, steel, stainless steel or aluminum.

The positive electrochemically active material can be any of the prior art materials that can be used in a rechargeable lithium storage cell, such as a transition metal oxide, a sulfide, a sulfate, and mixtures thereof. The positive electrode active material preferably includes one or more oxides of a transition metal, selected from vanadium oxide, lithium-manganese oxide, lithium-nickel oxide, lithium-cobalt oxide, and mixtures thereof.

The organic solvent is a solvent or a mixture of solvents selected from the usual solvents, in particular saturated cyclic carbonates, unsaturated cyclic carbonates, noncyclic carbonates, alkyl esters, such as formates, acetates, propionates or butyrates, ethers, and mixtures thereof. Saturated cyclic carbonates include, for example, ethylene carbonate (EC), propylene carbonate (PC), butylene carbonate (BC), and mixtures thereof. Unsaturated cyclic carbonates include, for example, vinylene carbonate (VC), its derivatives, and mixtures thereof. Noncyclic carbonates include, for example, dimethyl carbonate (DMC), diethyl carbonate (DEC), ethyl methyl carbonate (EMC), and mixtures thereof. Alkyl esters include, for example, methyl acetate, ethyl acetate, methyl propionate, ethyl propionate, butyl propionate, methyl butyrate, ethyl butyrate, propyl butyrate, and mixtures thereof. Ethers include, for example, dimethyl ether (DME) and mixtures thereof.

The conductive lithium salt can be lithium perchlorate LiClO₄, lithium hexafluoroarsenate LiAsF₆, lithium hexafluorophosphate LiPF₆, lithium tetrafluoroborate LiBF₄, lithium trifluoromethanesulfonate LiCF₃SO₃, lithium trifluoromethanesulfonimide LiN(CF₃SO₂)₂ (LiTFSI), or lithium trifluoromethane-sulfonemethide LiC(CF₃SO₂)₃ (LiTFSM).

The invention further provides a method of fabricating a rechargeable lithium storage cell including the following steps for producing the negative electrode. The binder is obtained in the form of a solution or a dispersion in an aqueous solvent. The non-fluorinated polymers that can be used for the solvent must be soluble in water or form a stable emulsion (latex) in suspension in water. The powdered active material and optional fabrication auxiliaries, such as a thickener, for example, are added to the solution or dispersion to form a paste. The viscosity of the paste is adjusted with water and at least one face of the conductive support is covered with the paste to form the active layer. The support covered with the active layer is dried and rolled to obtain the required porosity, which is from 20% to 60%, and this produces the electrode.

Other features and advantages of the present invention will become apparent from the following examples, described by way of nonlimiting and illustrative example only, of course, and from the accompanying drawings.

### BRIEF DESCRIPTION OF THE DRAWINGS

FIG. 1 shows the evolution of the reversible capacity per unit mass during cycling of a button cell in accordance with the invention and a prior art cell; the reversible capacity per unit mass C in mAh/g of the active material is plotted on the y-axis and the number N of cycles on the x-axis.

FIG. 2 is analogous to FIG. 1 for a different electrolyte.

FIG. 3 is the spectrum obtained by performing a differential scanning calorimetry (DSC) test on a negative electrode of a cell according to the invention; the thermal power W in mW/mg of active material is plotted on the y-axis and the temperature T in °C. on the x-axis.

FIGS. 4a, 4b and 4c show the first three cycles of a storage cell according to the invention.

FIGS. 5a, 5b and 5c are respectively analogous to FIGS. 4a, 4b and 4c but for a storage cell including a positive electrode whose active material is different.

### DETAILED DESCRIPTION OF THE PREFERRED EMBODIMENTS

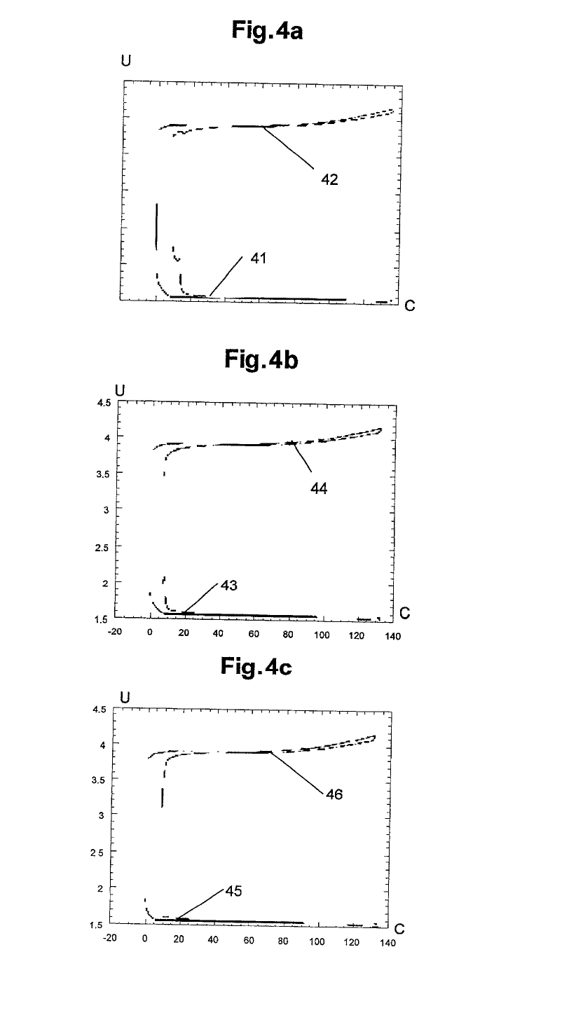

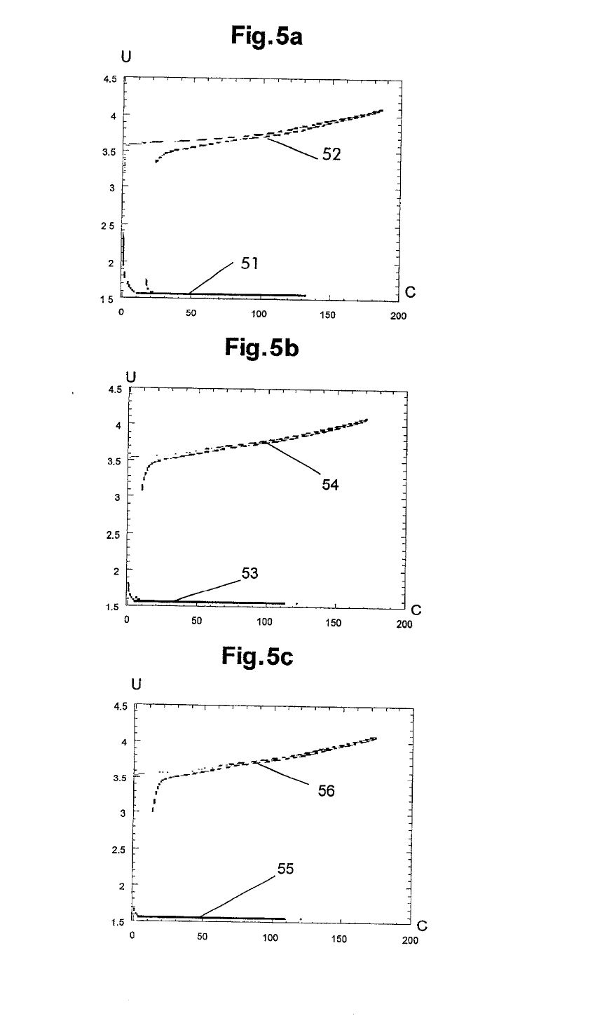

In FIGS. 4a, 4b and 4c and in FIGS. 5a, 5b and 5c the voltage U in V relative to Li+is plotted on the y-axis and the capacity C in mAh/g of the active material of the electrode concerned is plotted on the x-axis (the capacity is expressed for the positive electrode in mAh/g of positive active material and for the negative electrode in mAh/g of negative active material).

### EXAMPLE 1

A negative electrode in accordance with the invention was prepared 20 consisting of a paste supported by a conductive aluminum tape. The paste had the following composition:

| electrochemically active | | Li_{4/3}Ti_{5/3}O₄94% |
|---|---|---|
| material: | | |
| binder: | SBR | 2% |
| | CMC with MW > 200 000 | 2% |
| conductive material: | finely divided soot | 2% |

The powdered active material was added to the SBR in 51 wt % concentration solution in water. The CMC in 1 wt % concentration solution in water was then added to the mixture. The carboxymethylcellulose used was a CMC of high viscosity, i.e. one having an average molecular weight from 325 000 to 435 000. The paste obtained was spread on a copper tape, after which the electrode was dried in air at room temperature and then rolled to obtain a porosity from 40% to 60%.

The other electrode was a foil of lithium metal. A microporous polyolefin separator was placed between the electrodes to form an electrochemical bundle. The electrochemical bundle was impregnated with an electrolyte consisting of the lithium salt LiPF₆ in 1M solution in a 2/2/1 by volume EC/DMC/DEC solvent. A test button cell was then obtained.

### EXAMPLE 2

A test button cell Ib was made in a similar way to example 1 except that it contained an electrode consisting of the lithium salt LiPF₆ in 1M solution in a 1/1/3 by volume PC/EC/DMC solvent.

### EXAMPLE 3

A test button cell ha was made similar to that of example 1 except that it contained an electrode in accordance with the invention whose paste had the following composition:

| electrochemically active | | Li_{4/3}Ti_{5/3}O₄94% |
|---|---|---|
| material: | | |
| binder: | NBR | 2% |
| | CMC with MW > 200 000 | 2% |
| conductive material: | finely divided soot | 2% |

The powdered active material was added to the NBR in 41 wt % concentration solution in water. CMC in 1 wt % concentration solution in water was then added to the mixture. The carboxymethylcellulose used was a CMC of high viscosity, i.e. having an average molecular weight from 325 000 to 435 000. The paste obtained was spread on an aluminum tape, after which the electrode was dried in air at room temperature and then rolled to obtain a porosity from 40% to 60%.

### EXAMPLE 4 (COMPARATIVE)

A test button cell IIIa was made similar to that of example 1 except that it contained an electrode in accordance with the invention whose paste had the following composition:

| electrochemically active | | Li_{4/3}Ti_{5/3}O₄91% |
|---|---|---|
| material: | | |
| binder: | PVDF | 7% |
| conductive material: | finely divided soot | 2% |

A 7% concentration solution of PVDF in N-methylpyrrolidone (NMP) was prepared and the powdered active material was then added progressively to the solution. The paste obtained was spread on an aluminum tape, after which the electrode was dried in a vacuum at 120° C. and then rolled to obtain a porosity from 40% to 60%.

### EXAMPLE 5 (COMPARATIVE)

A test button cell IIIb similar to that of example 4 was produced except that it contained an electrolyte consisting of the lithium salt LiPF₆ in 1M solution in a 1/1/3 by volume PC/EC/DMC solvent.

### EXAMPLE 6 (COMPARATIVE)

A test button cell IVa was produced similar to that of example 4 except that it contained an electrode in accordance with the invention whose paste had the following composition:

| electrochemically active | | Li_{4/3}Ti_{5/3}O₄88% |
|---|---|---|
| material: | | |
| binder: | PVDF | 10% |
| conductive material: | finely divided soot | 2% |

The resulting test cells were evaluated during galvanostatic cycling in the following manner:

cycle 1 at room temperature at a rate of 10 mA/g of graphite,

cycles 2 to 50 at 60° C. at a rate of 20 mA/g of graphite.

The results obtained are set out in table I below. The irreversible capacity Cir and the reversible capacity Crev in mAh/g were measured and the loss of capacity ΔC per cycle was calculated for a number N of cycles.

TABLE I

| Reference | Binder | Cir | Crev | N | ΔC |
|---|---|---|---|---|---|
| Ia | 2% SBR + 2% CMC | 10 | 137 | 50 | 0.03 |
| IIa | 2% NBR + 2% CMC | 10 | 137 | 50 | |
| IIIa | PVDF 7% | 10 | 137 | 50 | 0.15 |
| IVa | PVDF 10% | 12 | 136 | 10 | 0.53 |
| Ib | 2% SBR + 2% CMC | 7 | 140 | 50 | 0.03 |
| IIIb | PVDF 7% | 11 | 137 | 50 | 0.10 |

These first tests showed up important differences between the organic solvent and the aqueous solvent with regard to stability on cycling.

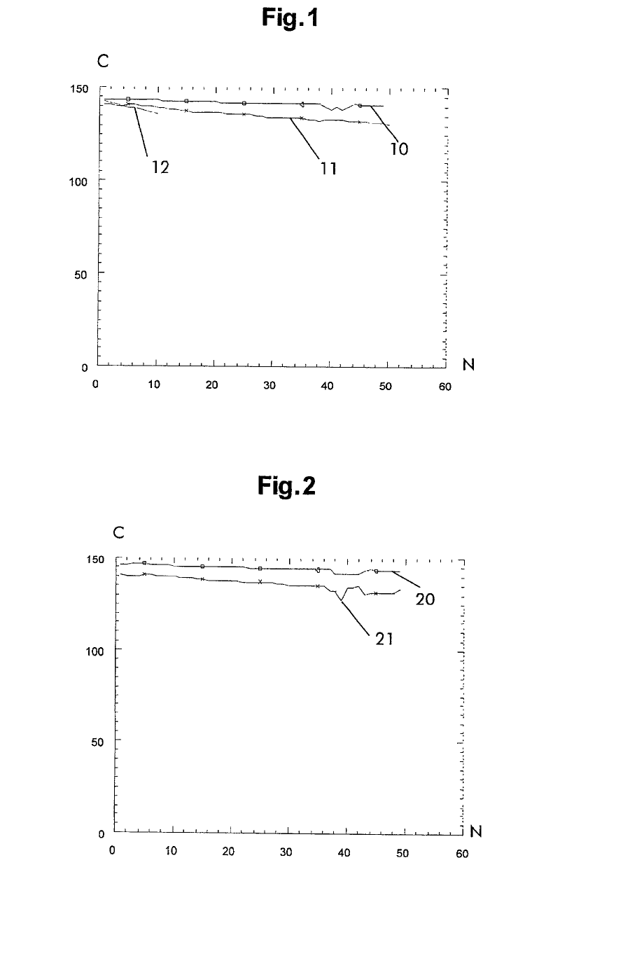

FIG. 1 shows that starting from a comparable initial capacity, the test cell Ia containing an electrode with a binder containing no fluorine (curve 10) had a loss of capacity on cycling that was at least five times lower than that observed for the cells IIIa and IVa containing an electrode with a fluorinated binder (curves 11 and 12).

FIG. 2 shows that the test cell Ib containing an electrode with a binder containing no fluorine (curve 20) had an initial capacity greater than the cell IIIb containing an electrode with a fluorinated binder (curve 21) and a loss of capacity of cycling three times lower than the latter cell.

After two charge/discharge cycles at room temperature, the thermal stability of the active material was evaluated by a differential scanning calorimetry (DSC) test, which is a technique for determining the variation of the thermal flux in a sample subjected to a programmed temperature. When a material is heated or cooled, its structure changes, and these transformations occur with exchange of heat. The DSC analysis indicates the transformation temperature (endothermic or exothermic peak) and the thermal energy (area under the peak) required for the transformation.

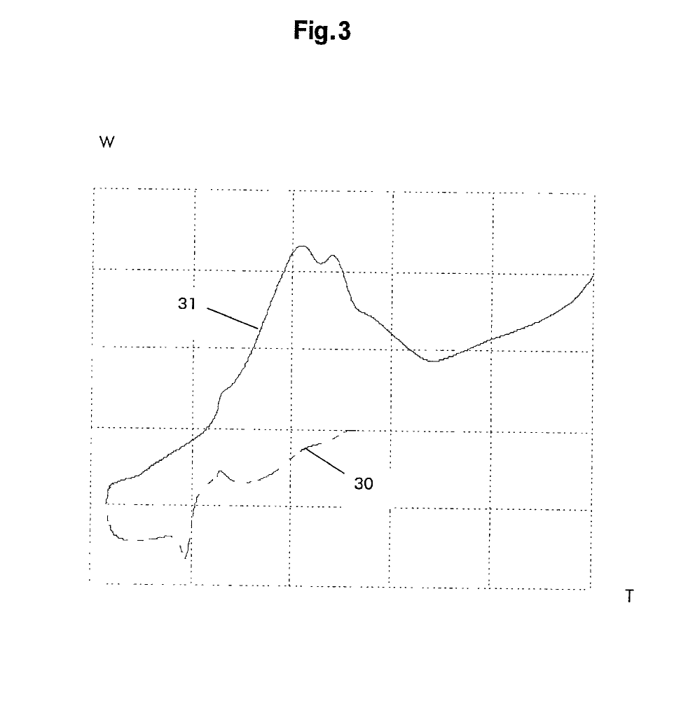

FIG. 3 shows that the electrode containing a binder containing no fluorine (curve 30) had an energy of the order of 330 J/g with no significant peak, whereas the electrode containing a fluorinated binder (curve 31) had a peak at around 200° C. to 250° C., corresponding to an energy of 1.40 kJ/g. The absence of fluorine in the binder therefore thermally stabilized the electrode.

### EXAMPLE 7

A button storage cell in accordance with the invention was produced containing a negative electrode similar to that of example 1 and a conventional positive electrode containing an active layer on a support in the form of an aluminum tape, the active layer containing an active material that consisted of lithium cobalt oxide LiCoO₂ with a PVDF binder. A microporous polyolefin separator was placed between the positive and negative electrodes to form an electrochemical bundle. Finally, the electrochemical bundle was impregnated with an electrolyte consisting of the lithium salt LiPF₆ in 1M solution in a 1/1/3 by volume PC/EC/DMC solvent. A button storage cell Vb was then obtained.

### EXAMPLE 8

A button storage cell VIb similar to that of example 7 was produced except that it contained a positive electrode whose active material was a mixed lithium oxide LiNiCoAlO₂.

The resulting cells were evaluated by galvanostatic cycling at 25° C. at a rate of Ic/20, where Ic is defined as the current needed to discharge the nominal capacity Cn of the storage cell in one hour.

FIGS. 4a, 4b and 4c and 5a, 5b and 5c show the good stability of the negative electrode according to the invention (curves 41, 43, 45 and curves 51, 53, 55) compared to two positive electrodes containing a different active material, respectively a lithium cobalt oxide LiCoO₂ (curves 42, 44, 46) and a mixed lithium oxide LiNiCoAlO₂ (curves 52, 54, 56). The curves showed little polarization, and the capacities C in mAh/g were virtually constant, as shown in table II below.

TABLE II

| Reference | Electrode | 1st cycle | 2nd cycle | 3rd cycle |
|---|---|---|---|---|
| Vb | (−) Li_{4/3}Ti_{5/3}O₄ | 127 | 125 | 125 |
| | (+) LiCoO₂ | 126 | 124 | 122 |
| Vib | (−) Li_{4/3}Ti_{5/3}O₄ | 116 | 116 | 113 |
| | (+) LiNiCoAlO₂ | 163 | 163 | 161 |

Of course, the present invention is not limited to the embodiments described, but lends itself to many variants that will be obvious to a person skilled in the art and that do not depart from the scope of the invention. In particular, without departing from the scope of the invention, the composition of the hydroxide and the nature of the syncrystallized substances can be modified. Use of an electroconductive support of a different kind and with a different structure could equally well be envisioned. Finally, the various ingredients of the paste and their relative proportions can be changed. In particular, additives to facilitate forming the electrode, such as a thickener or a texture stabilizer, can be incorporated therein in small proportions.

There is claimed:

1. A rechargeable lithium storage cell including a positive electrode, whose electrochemically active material includes one or more oxides of a transition metal, and a negative electrode, consisting of a conductive support and an active layer containing a binder and an electrochemically active material which is a mixed oxide of lithium and titanium with the general formula LiₓTi_{y}O₄ in which 0.8≦x≦1.4 and 1.6≦y≦2.2, in which storage cell said binder is a polymer containing no fluorine.

2. The storage cell claimed in claim 1 wherein said non-fluorinated polymer is soluble in water or capable of forming a stable emulsion in suspension in water.

3. The storage cell claimed in claim 1 wherein said binder contains an elastomer.

4. The storage cell claimed in claim 3 wherein said elastomer is selected from an acrylonitrile/butadiene copolymer and a styrene/butadiene copolymer.

5. The storage cell claimed in claim 3 wherein the proportion of said elastomer is from 30 wt % to 70 wt % of said binder.

6. The storage cell claimed in claim 1 wherein said binder contains a cellulose compound.

7. The storage cell claimed in claim 6 wherein said cellulose compound is carboxymethylcellulose.

8. The storage cell claimed in claim 6 wherein the proportion of said cellulose compound is from 30 wt % to 70 wt % of said binder.

9. The storage cell claimed in claim 1 wherein said binder includes a mixture of an elastomer and a cellulose compound.

10. The storage cell claimed in claim 9 wherein said binder includes a mixture of carboxymethylcellulose and an acrylonitrile/butadiene copolymer.

11. The storage cell claimed in claim 9 wherein said binder includes a mixture of carboxymethylcellulose and a styrene/butadiene copolymer.

12. The storage cell claimed in claim 9 wherein the proportion of said elastomer is from 30 wt % to 70 wt % of said binder and the proportion of said cellulose compound is from 30 wt % to 70 wt % of said binder.

13. The storage cell claimed in claim 9 wherein the proportion of said elastomer is from 50 wt % to 70 wt % of said binder and the proportion of said cellulose compound is from 30 wt % to 50 wt % of said binder.

14. The storage cell claimed in claim 1 wherein the active material of said positive electrode includes one or more oxides of a transition metal, selected from vanadium oxide, lithium manganese oxide, lithium nickel oxide, lithium cobalt oxide, and mixtures thereof.

15. A method of fabricating a storage cell as claimed in claim 1, including the following steps for producing said negative electrode:
placing said binder in the form of a solution or a dispersion in an aqueous solvent,
adding said powdered active material and optional fabrication auxiliaries to said solution or dispersion to form a paste,
adjusting the viscosity of said paste with water,
covering at least one face of said conductive support with paste to form said active layer, and
drying and rolling said support covered with said active layer to obtain said electrode.
